(19) United States
(12) Patent Application Publication
(10) Pub. No.: US 2008/0303314 A1
(43) Pub. Date: Dec. 11, 2008

(54) Device for Mounting an Opening Panel to the Body of a Motor Vehicle

(75) Inventor: Alain Aleman, Trappes (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/914,823

(22) PCT Filed: Apr. 21, 2006
(86) PCT No.: PCT/FR06/50367

§ 371 Date: Jun. 27, 2008

(30) Foreign Application Priority Data
May 18, 2005 (FR) 05-51286

(51) Int. Cl. B60J 5/00

(52) U.S. Cl. 296/202

(57) ABSTRACT

A device for mounting an opening panel to a body of a motor vehicle. A positioning mechanism positions the opening panel in relation to the body in a determined fitting position, which is geometrically defined in a reference trihedral of the body. The positioning mechanism includes a temporary mounting structure including: (i) a first mechanism positioning the structure in relation to the body, using a first given reference system, in a use position in which the structure is solidly connected to the body; and (ii) a second mechanism that cooperates with a complementary mechanism on the opening panel to position the opening panel, using a second given reference system, in the fitting position thereof in relation to the assembly formed by the structure and the body.

The invention relates to a device for mounting an opening panel on the body of a motor vehicle.

The invention relates more specifically to a device for mounting an opening panel, such as a door, on the body of a motor vehicle, of the type comprising means for positioning the opening panel with respect to the body in a determined position known as the fitting position, which is defined geometrically in a three-dimensional axis system (X, Y, Z) formed by the longitudinal axis X, the transverse axis Y and the vertical axis Z of the body so that the opening panel, thus positioned, can be fitted on the body of the vehicle.

Numerous devices of this type for mounting opening panels such as front and rear side doors on the bodies of vehicles are known. These devices are used at least at one of the stations on a vehicle assembly line.

There is a main distinction drawn between two layouts of assembly stations for fitting opening panels on such assembly lines.

In a first layout, the opening panels are mounted at a stationary work station, that is to say on a stationary vehicle body whereas, by contrast, in the second layout, the opening panels are mounted dynamically “on the fly” that is to say while the vehicle body is progressing along the assembly line.

In the first layout, use is generally made of complicated automated or non-automated tools which are capable of picking up an opening panel, such as a door comprising pre-mounted fittings or hinges, from a storage station and of positioning the opening panel relative to the body in a determined fitting position which is defined with respect to the reference frame (X, Y, Z) of the vehicle body.

With the opening panel thus geometrically positioned relative to the body, it is then mounted or fitted on the body using fixing means, such as screws or bolts, which are housed in complementary holes that the body possesses.

It is therefore essential to have precise control over the positioning of the opening panel relative to the body during the operation of mounting the opening panel in order to ensure that the opening panel is correctly positioned, and in particular, that the opening panel lies perfectly flush with the body.

Now, positioning the opening panel in its ultimate fitting position is dependent on numerous parameters such as the accuracy with which the tool is positioned, variations in the position of the body and therefore of the reference frame, or manual interventions on the part of the operator.

Similarly, in the second layout known as the “on the fly” layout, use is made of positioning tools which are mounted such that they can move in order to travel along the assembly line and which have therefore to be slaved in terms of their position relative to the movement of the reference frame (X, Y, Z) of the vehicle body. Tools such as these are therefore particularly expensive and, what is more, they are difficult to install along the assembly line.

There is therefore, over and above the aforementioned parameters that influence positioning in the first layout, an additional risk that there will be some deviation in the position of the opening panel thus making it particularly difficult to design tools which means that the quality of the finish of opening panels fitted in this way is somewhat variable.

With the second layout, positioning problems are generally observed which cause or require unplanned stoppages of the assembly line which, in addition to the design difficulties already encountered, are highly detrimental to productivity and particularly to adhering to target production rates.

As a result, the positioning means known in the prior art are not entirely satisfactory.

It is an object of the invention to propose a device for mounting an opening panel on the body that comprises positioning means which are, in particular, economical, reliable and easy to use.

To this end, the invention proposes a device for mounting an opening panel on the body of a motor vehicle of the aforementioned type, characterized in that the positioning means comprise a temporary mounting structure comprising, on the one hand, first means for positioning the structure, according to a first given reference frame X1, Y1, Z1, relative to the body in a position of use in which the structure is secured to the body and, on the other hand, second means which collaborate with complementary means belonging to the opening panel for positioning the opening panel, according to a second given reference frame X2, Y2, Z2, in its fitting position with respect to the entity formed by the structure and the body.

By virtue of the invention, the positioning means can be deployed quickly and easily, particularly when starting up production of a new vehicle type, and guarantee quality and reliable mounting of the opening panels such as the front and rear doors.

According to other features of the invention:
the first means comprise means of temporarily attaching the structure to the body in such a way as to position the structure relative to the body with respect to a first two X1, Z1 of the three axes X1, Y1, Z1 of the first reference frame, such as the longitudinal axis X1 and the vertical axis Z1, which determine the position of use of the structure with respect to the three-dimensional axis system (X, Y, Z) of the body;
the second means comprise means of temporarily fixing the opening panel to the structure so as to position the opening panel relative to the structure with respect to a first two X2, Z2 of the three axes X2, Y2, Z2 of the second reference frame, such as the longitudinal axis X2 and the vertical axis Z2, which determine the fitting position of the opening panel relative to the three-dimensional axis system (X, Y, Z) of the body;
the first means comprise means for locking the structure in the position of use on the body, which locking means are mounted such that they can move between a position of rest and a locked position in which they immobilize and position the structure relative to the body with respect to the last Y1 of the three axes X1, Y1, Z1 of said first reference frame;
the second means comprise means for locking the opening panel in the fitting position on the structure mounted in the position of use, which locking means are mounted such that they can move between a position of rest and a locked position in which they immobilize and position the opening panel relative to the structure and the body with respect to the last Y2 of the three axes X2, Y2, Z2 of said second reference frame;
the means of attaching the structure to the body and/or the means for fixing the opening panel to the structure comprise three points termed attachment points A1, A2, A3 and fixing points F1, F2, F3, respectively, which are distributed in such a way as to form a triangle of maximum area;
the three attachment points A1, A2, A3 in a triangle are situated on the two vertical sides of the surround of the opening panel that the body has;
the fixing points F1, F2, F3 for fixing the opening panel to the structure are situated near the vertexes of a triangular skeleton that forms the framework of the structure;
the structure comprises centering means such as locators which collaborate with complementary means belonging to the body and/or to the opening panel to guide and assist with mounting the structure on the body in the position of use and/or with mounting the opening panel on the structure in the fitting position;
the structure is made of a strong lightweight material such as carbon fiber.

Other features and advantages of the invention will become apparent from reading the detailed description which follows, for an understanding of which reference will be made to the attached figures among which:

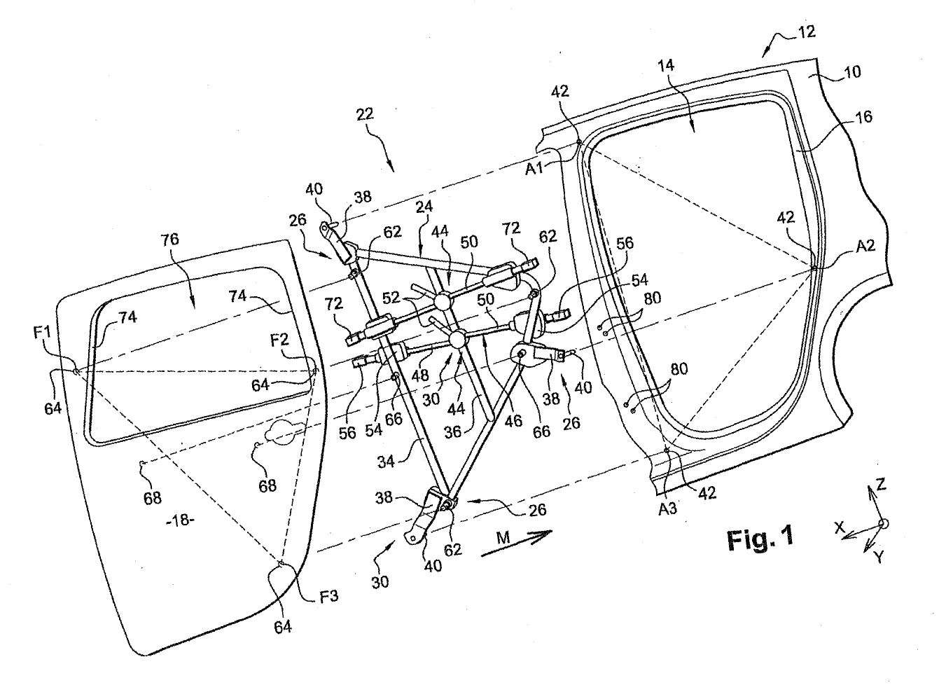

FIG. 1 is a schematic side view depicting, in an exploded view prior to mounting, a temporary mounting structure according to the teachings of the invention and which is intended to position a rear side door so that it can be fitted on the body of the vehicle;

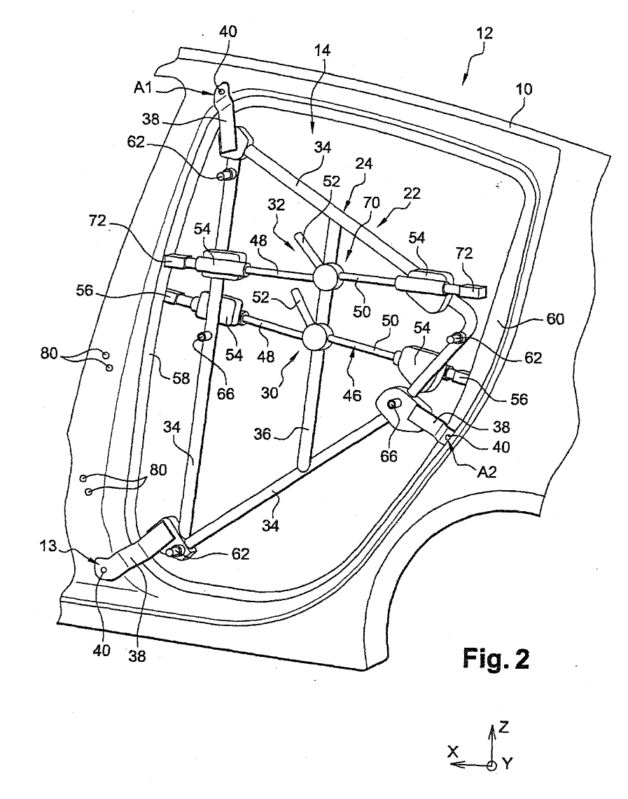

FIG. 2 is a schematic view depicting the mounting structure of FIG. 1 mounted on the body in the position of use with respect to a given first reference frame X1, Y1, Z1;

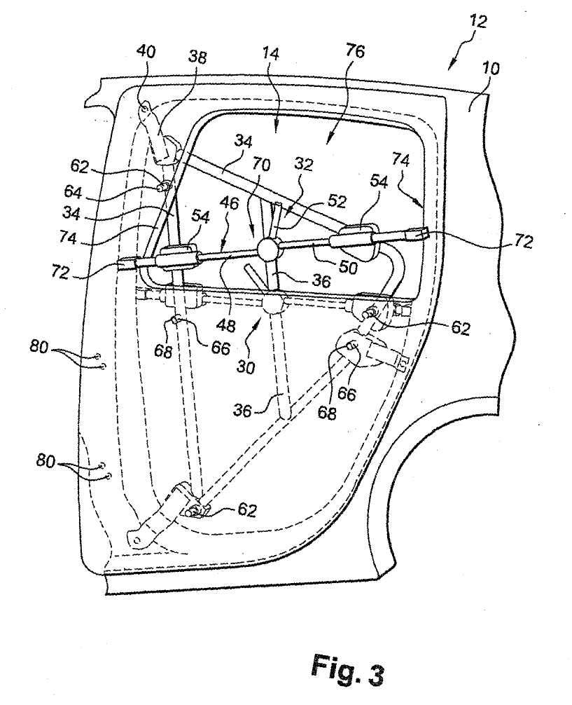

FIG. 3 is a schematic view depicting the side door mounted on the mounting structure positioned relative to the structure with respect to a given second reference frame X2, Y2, Z2 in its fitting position;

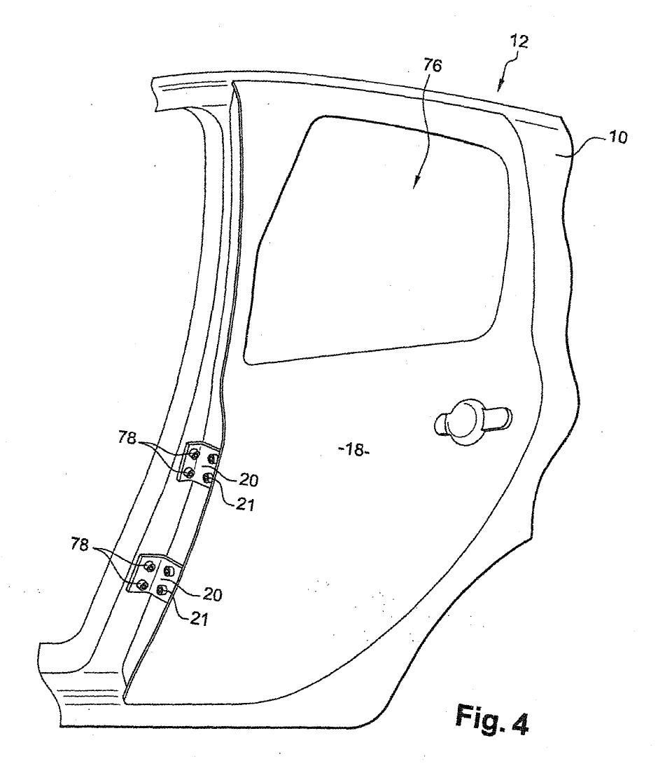

FIG. 4 is a schematic view depicting the side door after it has been fitted on the body and the temporary mounting structure has been removed.

In the description and the claims, use will be made nonlimitingly of expressions such as “rear” and “front” and “left” and “right”, or “upper” and “lower” and the orientations “longitudinal”, “transverse” and “vertical” with reference to the three-dimensional axis system (X, Y, Z) depicted in the figures and to the definitions given in the description.

In addition, elements of the invention which are identical, similar or analogous will be denoted by the same reference numerals.

FIG. 1 partially depicts the left rear side part of a body 10 of a motor vehicle 12 comprising a lateral opening 14 which delimits a door surround 16 and is able to be closed by a door 18.

Conventionally, the door 18 is mounted on the body 10 via fittings 20, more particularly illustrated in FIG. 4, which are secured to the door 18 on which they 20 are advantageously pre-mounted using fixing means 21 such as two screws per fitting.

The operation of mounting the door 18 on the body 10 is therefore also known as the operation of fitting the door 18.

Thus, by virtue of the fittings 20, the door 18 is mounted such that it can pivot about a generally vertical axis between a closed position in which the door 18 is flush with the body 10, and an open position for accessing the inside of the vehicle 12 or leaving it via the opening 14.

The operation of mounting the door 18 on the body 10 is performed using a device 22 for mounting an opening panel, such as the door 18 in this instance, which comprises means for positioning the door 18 relative to the body 10 in a determined position known as the fitting position.

The fitting position of the door 18 is defined geometrically in a three-dimensional axis system (X, Y, Z) depicted in FIG. 1 and which is formed of the longitudinal axis X, the transverse axis Y and the vertical axis Z of the body 10.

According to the invention, the positioning means of the device 22 comprise a temporary mounting structure 24 comprising, on the one hand, first means 26 for positioning the structure 24, according to a first given reference frame X1, Y1, Z1, relative to the body 10 in a position of use in which the structure 24 is secured to the body 10 and, on the other hand, second means 28 for positioning the door 18, according to a second given reference frame X2, Y2, Z2, in its fitting position with respect to the entity consisting of the structure 24 and the body 10.

Advantageously, the first and second positioning means 26, 28 are borne by the temporary mounting structure 24 so that mounting the structure 24 on the body 10 in the position of use with respect to the first reference frame X1, Y1, Z1 automatically determines the fitting position of the door 18 with respect to the second reference frame X2, Y2, Z2.

To do this, the first means 26 comprise means 30 of temporarily attaching the structure 24 to the body 10 in such a way as to position the structure 24 relative to the body 10 with respect to a first two axes, in this instance the longitudinal axis X1 and the vertical axis Z1, of the three axes X1, Y1, Z1 of the first reference frame which determine the position of use of the structure 24 with respect to the three-dimensional axis system (X, Y, Z) of the body 10.

Likewise, the second means 28 comprise means 32 of temporarily fixing the door 18 to the structure 24 in such a way as to position the door 18 relative to the structure 24 in the determined fitting position and which means will be described in detail later.

According to a preferred embodiment, the temporary mounting structure 24 comprises an external skeleton 34, of overall triangular shape, forming the tubular main framework of the structure and at least one internal support crosspiece 36 which is secured to the external skeleton 34.

The means 30 of attaching the structure 24 to the body 10 consist, for example, of bearing tabs 38, in this instance three of them, each comprising at least one peg 40 extending transversely to the right, that is to say toward the body 10.

In the position of use, each peg 40 is housed in a complementary hole 42 that the body 10 comprises for the attachment of the structure 24.

Advantageously, the holes 42 are holes that already exist on the body 10 and which are intended to be used later for other purposes so that no additional drilling is required to allow the structure 24 to be mounted on the body 10.

Advantageously, the bearing tabs 38 are more or less arranged near the vertexes of the external skeleton 34 of the structure 24 and each tab 38 has a profile that complements that part of the door surround 16 on which the tab 38 will, as illustrated in FIG. 2, bear when the structure 24 is in the position of use.

The structure 24 is mounted on the body 10 in the transverse direction from left to right in the direction of the arrow M depicted in FIG. 1.

The structure 24 is, for example, positioned manually by an operator who positions the structure 24 in such a way that the pegs 40 that project from the skeleton 34 enter the corresponding holes 42 in the body 10.

The structure 24 is thus advantageously positioned relative to the body 10 with respect to the longitudinal axis X1 and the vertical axis Z1 of the given first reference frame X1, Y1, Z1 which corresponds to its position of use.

In addition, the first means 26 comprise means 44 of locking the structure 24 on the body 10 in its position of use.

Advantageously, the structure 24 is automatically positioned with respect to the transverse last Y1 of the three axes X1, Y1, Z1 of the first reference frame when the structure 24 is locked to the body 10.

The locking means 44 of the first means 26 are borne by the internal crosspiece 36 and the external skeleton 34 of the structure 24.

More specifically, the locking means 44 consist of at least one locking bar 46 which is mounted such that it can move longitudinally between a position of rest in which the bar 46 does not impede the mounting of the structure 24 on the body 10 and a locked position in which the bar 46 immobilizes the structure 24 relative to the body 10.

The locking bar 46 extends generally in the longitudinal direction and has a front locking arm 48 and a rear locking arm 50 respectively.

The locking arms 48, 50 can be actuated by a control means, in this instance a handle 52, which acts on one of the ends of each of the arms 48, 50 in such a way as to cause it to slide longitudinally forward or, respectively, backward, from the position of rest into the locked position.

The longitudinal sliding in opposite directions of each of the arms 48, 50 corresponds to a locking travel for the bar 46.

As a preference, the free other end of each of the locking arms 48, 50 slides, forward or backward, on a guide support 54 which is secured to the external skeleton 34.

Each locking arm 48, 50 has, at its free end, a shoe 56 which, in the locked position, projects longitudinally from the external skeleton 34 so as to collaborate with the door surround 16 of the body 10.

Each front and rear shoe 56 of the locking bar 46 bears against the internal vertical surface of the body 10 which is transversely opposite the external vertical surface against which the tabs 38 bear, so as to immobilize the structure 24 on the body 10 by gripping and so as to position it with respect to the transverse axis Y1 in its position of use.

Advantageously, the geometric position of the holes 42 or of the pegs 40 is determined in such a way as to form a triangle of maximum area and the vertexes of which generally constitute three points of attachment of the structure 24, hereinafter denoted A1, A2 and A3.

As can be seen better in FIG. 2 which illustrates the structure 24 in the position of use on the body 10, the three attachment points A1, A2, A3 are situated on the more or less rectangular periphery of the door surround 16 of the door 18.

More specifically, the attachment points A1, A2, A3 are situated on the two vertical edges of the door surround 16, the points A1 and A3 being situated respectively in the top corner and in the bottom corner that the front vertical edge 58 forms with the upper and lower longitudinal edges, while the last point A2 is situated on the rear vertical edge 60, substantially mid-way up this edge.

What is more, the attachment points A1, A2, A3 are positioned in such a way as to make it easier, once the door 18 has been fitted, to remove the temporary structure 24, which operations will be detailed later.

Advantageously, the structure 24 comprises centering means (not depicted) which collaborate with complementary means belonging to the body 10 to guide and ease the mounting of the structure 24 on the body 10 until such point as it is locked in the position of use.

Once the first step of mounting the structure 24 on the body 10 and of locking it in place in its position of use using the means 44 has been performed, the door 18 is then mounted on the structure 24 and therefore the body 10.

As mentioned earlier, the second means 28 comprise means 32 of temporarily fixing the door 18 to the structure 24.

These fixing means 32 allow the door 18 to be positioned relative to the structure 24 with respect to a first two axes, in this instance the longitudinal axis X2 and the vertical axis Z2, of the three axes X2, Y2, Z2 of the second reference frame which determine the fitting position of the door 18 relative to the three-dimensional axis system (X, Y, Z) of the body 10.

The means 32 for fixing the door 18 comprise studs 62 which are secured to the structure 24 from which they extend transversely to the left, toward the door 18. The studs 62 are intended, upon mounting, to enter complementary orifices 64 in the internal vertical face of the door 18, these being depicted in particular in outline in FIG. 1.

Advantageously, the geometric position of the three studs 62 is determined in such a way as to form a triangle of maximum area and the vertexes of which generally constitute three points via which the door 18 is fixed to the structure 24, these points being termed hereinafter F1, F2 and F3.

Advantageously, the structure 24 comprises means of centering the door 18, such as locators 66, which collaborate with complementary holes 68 in the door 18 to guide and assist with the mounting thereof on the structure 24 and the body 10 in the fitting position.

When the studs 62 are housed in the orifices 64 of the door 18, the door 18 is then positioned respectively with respect to the longitudinal axis X2 and the vertical axis z2 of the second reference frame X2, Y2, Z2.

The second means 28 also comprise means 70 of locking the door 18 so as to lock it in the fitting position on the structure 24 which has already been mounted on the body 10 in the position of use.

The locking means 70 belonging to the second means 28 in this instance are analogous to the locking means 44 belonging to the first means 26 described above.

The means 70 of locking the door 18 are mounted such that they can move between a position of rest and a locked position in which they immobilize and position the door 18 relative to the structure 24 and the body 10 with respect to the vertical last axis Y2 of the three axes X2, Y2, Z2 of the second reference frame.

The locking means 70 thus comprise a locking bar 46 consisting of two locking arms, a front 48 and a rear 150, which are actuated between the position of rest and the locked position by means of another handle 52.

The front 48 and rear 50 locking arms are mounted to slide longitudinally in a given locking travel and are guided at their free end by supports 54.

The locking means 70 comprise shoes 72 which, in the locked position, are advantageously housed in the vertical wells 74 of the door 18 which are intended to house a side window (not depicted) capable of sliding vertically therein.

In the absence of such a window which is mounted later, the actuating handle 52 of the locking means 70 is readily accessible to an operator through the opening 76 in the door 18 designed for said window.

As a preference, the attachment points A1, A2, A3 and the fixing points F1, F2, F3 of the structure 24 are positioned near the vertexes of the skeleton 34 of the triangular structure 24.

With the door 18 positioned in its fitting position illustrated in FIG. 3 once it has been mounted and locked on the structure 24, the door 18 is then fitted on the body 10, in this instance by fixing the two door fittings 20 using fixing means 78.

As can be seen best in FIG. 4, the fixing means consist for example of screws 78 which are housed in complementary holes 80 in the body 10 in order to fix the fittings 20 in place.

The door 18 is mounted securely on the body 10 with respect to which it is capable of pivoting via fittings 20 between its two extreme positions which are open and closed positions respectively.

In the closed position, the door 18 thus fitted is then positioned in such a way as to lie flush with the adjacent parts of the body 10.

Once the operation of fitting the door 18 has been completed, the temporary mounting structure 24 is then removed by first of all unlocking the means 70 that lock the door 18 to the structure 24 so as to allow the door to be opened. Next, the door 18 is opened in order to access the structure 24 which, once the means 44 that lock the structure 24 to the body 10 have been unlocked, can be removed by pulling in such a way as to disengage the pegs 40 from the holes 42 in order to completely release the structure 24.

As can be seen in FIG. 4, once the structure 24 has been removed, the door 18 is, in this instance, closed again onto the body 10 of the vehicle which continues its journey along the assembly line.

Advantageously, the temporary mounting structure 24 is made of a strong lightweight material such as carbon fiber or a similar material so that it is easy for an operator to handle at the production rates required.

The device for mounting the opening panel according to the invention is therefore particularly flexible to use particularly in that it does not require lengthy and expensive engineering development.

As a result, the temporary mounting structure 24 allows a very appreciable time saving, particularly when starting up a new assembly line.

Advantageously, the mounting structure can be used by an operator entirely independently of the other work stations that the assembly line has.

Of course, mounting the door 18 is merely one nonlimiting example of the mounting of an opening panel that can be positioned using the device according to the invention.

1-10. (canceled)

11. A device for mounting an opening panel, on a body of a motor vehicle, comprising:
means for positioning the opening panel with respect to the body in a determined fitting position, which is defined geometrically in a three-dimensional axis system formed by the longitudinal axis, the transverse axis, and the vertical axis of the body so that the opening panel, thus positioned, can be fitted on the body of the vehicle,
wherein the positioning means comprises a temporary mounting structure including (i) first means for positioning the structure, according to a first given reference frame, relative to the body in a position of use in which the structure is secured to the body, and (ii) second means that collaborates with complementary means belonging to the opening panel for positioning the opening panel, according to a second given reference frame, in its fitting position with respect to the entity formed by the structure and the body.

12. The device as claimed in claim 11, wherein the first means comprises means for temporarily attaching the structure to the body so as to position the structure relative to the body with respect to a first two of the three axes of the first reference frame, which determines the position of use of the structure with respect to the three-dimensional axis system of the body.

13. The device as claimed in claim 11, wherein the second means comprises means for temporarily fixing the opening panel to the structure so as to position the opening panel relative to the structure with respect to a first two of the three axes of the second reference frame, which determines the fitting position of the opening panel relative to the three-dimensional axis system of the body.

14. The device as claimed in claim 11, wherein the first means comprises means for locking the structure in the position of use on the body, which locking means is mounted to move between a position of rest and a locked position in which the locking means immobilizes and positions the structure relative to the body with respect to the last of the three axes, of the first reference frame.

15. The device as claimed in claim 14, wherein the second means comprises means for locking the opening panel in the fitting position on the structure mounted in the position of use, which locking means is mounted to move between a position of rest and a locked position in which the locking means immobilizes and positions the opening panel relative to the structure and the body with respect to the last of the three axes of the second reference frame.

16. The device as claimed in claim 11, wherein the means for attaching the structure to the body and/or the means for fixing the opening panel to the structure comprise three attachment points and fixing points, respectively, which are distributed to form a triangle of maximum area.

17. The device as claimed in claim 16, wherein the three attachment points in a triangle are situated on the two vertical sides of the surround of the opening panel of the body.

18. The device as claimed in claim 16, wherein the fixing points for fixing the opening panel to the structure are situated near vertexes of a triangular skeleton that forms a framework of the structure.

19. The device as claimed in claim 11, wherein the structure comprises centering means that collaborate with complementary means belonging to the body and/or to the opening panel to guide and assist with mounting the structure on the body in the position of use and/or with mounting the opening panel on the structure in the fitting position.

20. The device as claimed in claim 11, wherein the structure is made of a strong lightweight material.

21. The device as claimed in claim 11, wherein the structure is made of carbon fiber.
